(19) United States
(12) Patent Application Publication
(10) Pub. No.: US 2025/0303436 A1
(43) Pub. Date: Oct. 2, 2025

(54) COATING APPARATUS AND COATING SYSTEM

(71) Applicant: UCOS Co., Ltd., Kyoto-shi, Kyoto (JP)

(72) Inventors: Hiroo MICHII, Kyoto-shi (JP); Shigeo MIYAMOTO, Nara-shi (JP)

(73) Assignee: UCOS Co., Ltd., Kyoto-shi, Kyoto (JP)

(21) Appl. No.: 18/863,016

(22) PCT Filed: Jun. 9, 2023
(86) PCT No.: PCT/JP2023/021611

§ 371 Date: Nov. 5, 2024

(30) Foreign Application Priority Data
Mar. 2, 2023 (JP) 2023-032268

(51) Int. Cl. B05C 21/00; B05C 1/08; B05C 13/00

(52) U.S. Cl. CPC B05C 21/00; B05C 1/0826; B05C 13/00

(57) ABSTRACT

A coating apparatus including: a coating processing section configured to perform predetermined coating processing on a printed surface of a workpiece which is a sheet or a plate having a surface subjected to electronic printing processing; a pressurizing roller pair disposed on an upstream side or a downstream side of the coating processing section and configured to sandwich, pressurize and convey the workpiece; and a heating section disposed at the same position as or on an upstream side of the pressurizing roller pair with respect to a conveyance direction of the workpiece and configured to heat the printed surface of the workpiece.

### TECHNICAL FIELD

The present invention relates to a coating apparatus and a coating system configured to perform coating processing on a workpiece that is a sheet or a plate having a printed surface.

### BACKGROUND ART

Electronic printers (laser printer, LED printer, etc.) and inkjet printers are widely used for printing on a workpiece that is a sheet- or a plate-. In an electronic printer, toner is caused to adhere to a reverse image formed on a surface of a drum using a laser light or an LED light, and the toner is transferred to a surface of the workpiece and fixed on the surface by applying heat and pressure to form a printed layer on the surface. An inkjet printer forms a printed layer on a surface of a workpiece by spraying fine particles of liquid ink onto the surface.

In order to protect the printed layer formed on the surface of the workpiece or to make the printed layer glossy, coating of the surface (printed surface) of the workpiece after the printed layer is formed with a coating agent is usually performed (for example, Patent Literature 1).

### CITATION LIST

### Patent Literature

Patent Literature 1: JP S63-278847 A
Patent Literature 2: JP 2000-143030 A

### SUMMARY OF INVENTION

### Technical Problem

When we formed a coating layer on a workpiece on which printed layer had been formed using electronic printers and inkjet printers of various manufacturers, we found that the coating layer easily peeled off in some electronic printers.

An object of the present invention is to provide a technique for suppressing peeling of a coated layer after coating processing is performed on a workpiece that is a sheet or a plate subjected to electronic printing.

### Solution to Problem

A coating apparatus according to the present invention made to solve the above problems includes:
a coating processing section configured to perform predetermined coating processing on a printed surface of a workpiece that is a sheet-shaped object or a plate-shaped object having a surface subjected to electronic printing processing;
a pressurizing roller pair disposed on an upstream side or a downstream side of the coating processing section and configured to sandwich, pressurize and convey the workpiece; and
a heating section disposed at the same position as or on an upstream side of the pressurizing roller pair with respect to a conveyance direction of the workpiece and configured to heat the printed surface of the workpiece.

Various conventionally known coating processing can be used for the predetermined coating processing. Specific examples of such processing include coating processing with a UV varnish and coating processing with an aqueous varnish.

When the present inventors conducted a peeling test in which an adhesive tape was attached to a workpiece subjected to coating processing by a conventional coating apparatus and peeled off, it was found that the coated layer peeled off together with a part of the printed layer on the workpiece which was formed using some electronic printers. The printed layer of the printed matter created using the electronic printer is made of toner. The reason why the coated layer peels off together with a part of the printed layer is assumed that the toner is not sufficiently aggregated and not fixed on the printing surface when the printed matter is created in the electronic printer. In the present invention, in addition to the coating processing section configured to perform coating processing on a printed surface, the pressurizing roller pair disposed on the upstream side or downstream side of the coating processing section and configured to sandwich and pressurize the workpiece, and the heating section disposed at the same position as or on the upstream side of the pressurizing roller pair with respect to the conveyance direction of the workpiece and configured to heat the printed surface of the workpiece are provided. The printed surface is heated by the heating section, and the printed surface is directly pressurized by the pressurizing roller pair (when the pressurizing roller pair is disposed on the upstream side of the coating processing section), or the printed surface is indirectly pressurized with intermediation of the coating layer formed by the coating processing (when the pressurizing roller pair is disposed on the downstream side of the coating processing section). Therefore, the toner is properly aggregated and more reliably fixed on the printed surface, and the coated layer can be suppressed from peeling off after being subjected to the coating processing.

It is preferable that, in the coating apparatus according to the present invention,
the heating section is configured to heat the printed surface of the workpiece simultaneously with pressurization by the pressurizing roller pair.

In the coating apparatus of the above mode, the toner can be more efficiently aggregated and fixed on the printing surface.

It is preferable that, in the coating apparatus according to the present invention,
the pressurizing roller pair is disposed on the upstream side of the coating processing section, and
a surface of one roller of the pressurizing roller pair, the one roller being located on a side in contact with the printed surface, is made of a material having a friction coefficient of 0.1 or less.

In the coating apparatus of the above mode, since the printed surface is directly heated and pressurized without intermediation of the coating layer, the toner is properly aggregated and more reliably fixed on the printing surface. In the coating apparatus of the above mode, since the surface of the roller located on the side in contact with the printed surface is made of a material having a small friction coefficient of 0.1 or less, the adhesiveness and wettability of the surface of the roller are low, and the toner can be suppressed from adhering to the roller. As the material having a friction coefficient of 0.1 or less, for example, fluororesin can be used.

### Advantageous Effects of Invention

In the coating apparatus according to the present invention, since the toner is properly aggregated and fixed on the printing surface, it is possible to suppress separation of the toner layer and peeling of the toner layer together with the coated layer after the coating processing is performed on the workpiece subjected to the electronic printing processing.

### BRIEF DESCRIPTION OF DRAWINGS

FIG. 1 An overall configuration diagram of a coating apparatus according to a first embodiment of the present invention.

FIG. 2 A schematic diagram illustrating a configuration of a toner aggregation section of the coating apparatus of the first embodiment.

FIG. 3 A schematic diagram illustrating a configuration of a coating section of the coating apparatus of the first embodiment.

FIG. 4 A schematic diagram illustrating a configuration of a varnish curing section of the coating apparatus of the first embodiment.

FIG. 5 An overall configuration diagram of a coating apparatus according to a second embodiment of the present invention.

FIG. 6 A diagram illustrating a configuration of a workpiece cooling section of the coating apparatus of the second embodiment.

FIG. 7 A schematic diagram illustrating a configuration in the vicinity of a conveyance section for a paper sheet in the workpiece cooling section of the coating apparatus of the second embodiment.

### DESCRIPTION OF EMBODIMENTS

Two embodiments of a coating apparatus according to the present invention will be described below with reference to the drawings. Each of a coating apparatus 1 of a first embodiment and a coating apparatus 100 of a second embodiment is an apparatus configured to perform processing of coating a surface of a paper sheet, the surface having been subjected to printing (electronic printing) processing by an electronic printer (laser printer, LED printer, etc.), with a UV varnish. Note that, in the drawings used in the following description, each section is appropriately illustrated in a scale different from the actual scale in order to clearly illustrate the configuration of each section.

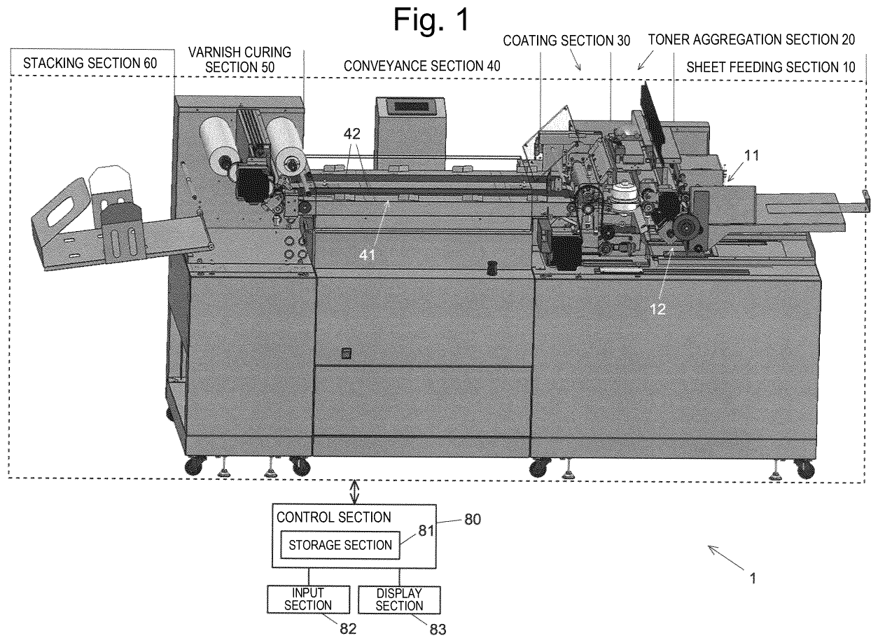

FIG. 1 is an overall perspective view of the coating apparatus 1 according to the first embodiment. However, in FIG. 1, in order to illustrate the internal structure, the upper surface and the side surface on the front side of the external casing and a part of the components inside the apparatus are not illustrated. The coating apparatus 1 includes a sheet feeding section 10, a toner aggregation section 20, a coating section 30, a conveyance section 40, a varnish curing section 50, and a stacking section 60 in this order from the upstream side where a paper sheet which is an object to be processed is conveyed. Each of the sheet feeding section 10 to the coating section 30, the conveyance section 40, the varnish curing section 50, and the stacking section 60 is unitized, and the coating apparatus 1 is configured by sequentially connecting the units. In addition, a control section 80 which controls operations of these sections is provided. For convenience of description, in the following description, the direction in which the paper sheet is conveyed is referred to as “front” for convenience.

The sheet feeding section 10 is an apparatus that supplies a paper sheet to the toner aggregation section 20 located at the subsequent stage, and includes a stacking section 11 and a conveyance mechanism 12. In the stacking section 11, paper sheets before the coating processing are stacked in advance such that the surface to be processed (coating surface) on which the printing processing has been performed faces upward. The conveyance mechanism 12 takes in the paper sheets stacked on the stacking section 11 one by one and supplies the paper sheets to the toner aggregation section 20.

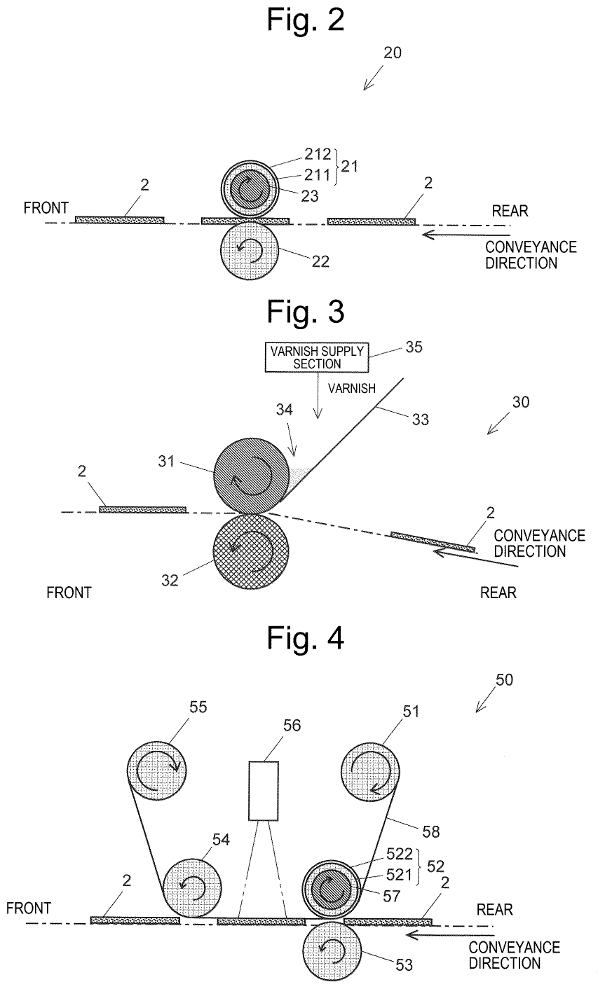

The toner aggregation section 20 is an apparatus that aggregates the toner of the printed layer of a paper sheet 2 supplied from the sheet feeding section 10 and fixes the toner on the printing surface. FIG. 2 schematically illustrates a configuration of the toner aggregation section 20. The toner aggregation section 20 includes a pair of rollers (upper roller 21, lower roller 22) disposed vertically. A halogen lamp 23 is incorporated in the upper roller 21. The lower roller 22 is disposed so as to press the paper sheet 2 supplied from the sheet feeding section 10 toward the upper roller 21, and the separation distance between the upper roller 21 and the lower roller 22 is shorter than the thickness of the paper sheet 2. Therefore, the paper sheet 2 drawn between the upper roller 21 and the lower roller 22 is pressurized by being sandwiched between the upper roller 21 and the lower roller 22, and is sent out while being heated by the halogen lamp 23.

The surface of the upper roller 21 is made of a material having a small friction coefficient. The upper roller 21 of the first embodiment is formed by winding a fluororesin tube 212 having a friction coefficient of 0.1 around a surface of a roller 211 made of rubber incorporating the halogen lamp 23, and the lower roller 22 is a roller made of rubber (rubber roller). In the first embodiment, the halogen lamp 23 corresponding to a heating section in the present invention is provided at the same position as the pressurizing roller pair including the upper roller 21 and the lower roller 22 in the conveyance direction of the paper sheet 2 which is a workpiece.

The coating section 30 is an apparatus that applies a UV varnish to the upper surface (surface to be processed) of the paper sheet 2 supplied from the toner aggregation section 20. The coating section 30 in the first embodiment has the same configuration as the coating section of the embodiment described in the previous application (JP 2022-172954) by the present applicant. Here, only the main part will be described.

The coating section 30 includes an upper roller 31 and a lower roller 32 above and below the path of the paper sheet 2 conveyed from the sheet feeding section 10. FIG. 3 schematically illustrates a configuration in the vicinity of the upper roller 31 and the lower roller 32 in the coating section 30. In the width direction of the peripheral surface of the upper roller 31, a groove is formed in a portion corresponding to the width of the paper sheet 2 to which the UV varnish is applied. As the upper roller 31, one made of a material having rigidity, for example, a gravure rod can be suitably used. The lower roller 32 includes an elastic roller portion and a rigid roller portion, the elastic roller portion having a width corresponding to a width for applying the UV varnish to the paper sheet 2 and being made of an elastic material (rubber or the like) at least on a peripheral surface, the rigid roller portion (metal collar) being disposed at both ends of the elastic roller portion and being made of a rigid material (stainless steel or the like). The diameter of the rigid roller portion (metal collar) is slightly larger than the diameter of the elastic roller portion (rubber roller) (for example, 0.2 mm), and this difference is smaller than the thickness of the paper sheet 2. As described above, by making the height difference between the surface of the elastic roller portion and the surface of the rigid roller portion (metal collar) smaller than the thickness of the paper sheet 2, the peripheral surface of the groove roller portion and the peripheral surface of the elastic roller portion can be separated from each other in a state where the paper sheet 2 is not sandwiched to prevent the UV varnish from adhering to the peripheral surface of the elastic roller portion, and the paper sheet 2 can be brought into contact with the peripheral surface of the groove roller portion to apply the UV varnish to the surface of the paper sheet 2 in a state where the paper sheet 2 is sandwiched.

On the peripheral surface of the upper roller 31, a doctor blade 33, which is a plate-shaped member in linear contact with the peripheral surface of the upper roller 31, is disposed at a position in front of the contact portion with the lower roller 32 in the rotation direction of the upper roller 31 (on the upstream side in the conveyance direction of the paper sheet 2). In addition, plate-shaped side wall members are provided at both ends of the portion where the upper roller 31 and the doctor blade 33 are in linear contact with each other so as to close the sides of the space sandwiched between the peripheral surface of the upper roller 31 and the surface of the doctor blade 33. A space surrounded by the upper roller 31, the doctor blade 33, and the side wall members is used as a varnish reservoir 34. The liquid varnish is supplied from a varnish supply section 35 provided above the varnish reservoir 34.

The conveyance section 40 is an apparatus that conveys the paper sheet 2 to which the UV varnish has been applied in the coating section 30 to the varnish curing section 50 located at the subsequent stage. The conveyance section 40 includes a conveyance table 41, two belts 42 wound around the conveyance table 41, and a driver which rotates the two belts 42 (not illustrated).

The varnish curing section 50 is an apparatus that cures the UV varnish applied to the paper sheet 2 conveyed from the conveyance section 40. FIG. 4 schematically illustrates a configuration of the varnish curing section 50. As illustrated in FIG. 4, the varnish curing section 50 includes a resin film supply roller 51, a resin film pressing first upper roller 52, a resin film pressing first lower roller 53, a resin film pressing second roller 54, a resin film collection roller 55, and a UV light source 56.

The resin film pressing first upper roller 52 and the resin film pressing first lower roller 53 have the same configuration as the upper roller 21 and the lower roller 22 in the toner aggregation section 20. That is, a halogen lamp 57 is incorporated in the resin film pressing first upper roller 52. The resin film pressing first lower roller 53 is disposed so as to press the paper sheet 2 from below toward the resin film pressing first upper roller 52, and the separation distance between the resin film pressing first upper roller 52 and the resin film pressing first lower roller 53 is shorter than the thickness of the paper sheet 2. Therefore, the paper sheet 2 drawn between the resin film pressing first upper roller 52 and the resin film pressing first lower roller 53 is pressurized by being sandwiched between the resin film pressing first upper roller 52 and the resin film pressing first lower roller 53, and is further sent out while being heated by the halogen lamp 57.

The surface of the resin film pressing first upper roller 52 is made of a material having a small friction coefficient. The resin film pressing first upper roller 52 of the first embodiment is formed by winding a fluororesin tube 522 around a surface of a roller 521 made of rubber incorporating the halogen lamp 57, and the resin film pressing first lower roller 53 is a rubber roller. In the first embodiment, the halogen lamp 57 corresponding to the heating section in the present invention is also provided at the same position as the pressurizing roller pair including the resin film pressing first upper roller 52 and the resin film pressing first lower roller 53 in the conveyance direction of the paper sheet 2 which is a workpiece.

The resin film supply roller 51 is formed by winding a long resin film 58. The resin film pressing first upper roller 52 and the resin film pressing first lower roller 53 sandwich the paper sheet 2 along a conveyance path (a path indicated by a one-dot chain line in FIG. 4) and convey the paper sheet 2. When the paper sheet 2 is sandwiched between the resin film pressing first upper roller 52 and the resin film pressing first lower roller 53, the resin film 58 supplied from the resin film supply roller 51 is pressed against the upper surface of the paper sheet 2. The resin film supply roller 51 rotates following this. As a result, the resin film 58 is airtightly attached to the upper surface of the paper sheet 2, and air (in particular, oxygen gas which inhibits the curing of the coating agent) existing between the resin film 58 and the paper sheet 2 is discharged. After curing the UV varnish, the resin film collection roller 55 winds and collects the resin film 58 from the paper sheet 2.

The UV light source 56 is provided at a position between the resin film pressing second roller 54 and the pressurizing roller pair including the resin film pressing first upper roller 52 and the resin film pressing first lower roller 53, and irradiates, with ultraviolet light, the UV varnish-applied surface of the paper sheet 2 to which the resin film 58 is airtightly attached. As the resin film 58, one that transmits ultraviolet light is used, and when the UV varnish is irradiated with ultraviolet light transmitted through the resin film 58, the UV varnish applied to the surface of the paper sheet 2 is cured. The paper sheet 2 from which the resin film 58 has been peeled off is sent out to and stacked on the stacking section 60. Here, the resin film 58 is used, but any other film may be used as long as it transmits light emitted from the light source 56 and can be airtightly attached to the upper surface of the paper sheet 2. In addition, since the resin film 58 is in direct contact with the printed surface, similarly to the surface of the upper roller 21, it is preferable that at least the surface on the side in contact with the printed surface is made of a material having a small friction coefficient. Specifically, a material having a friction coefficient equal to or less than 0.1 which is a friction coefficient of the fluororesin is preferable.

The control section 80 controls the operation of each section described above. An entity of the control section 80 is a computer, and a necessary function is implemented by executing a dedicated program installed in advance by a processor. The control section 80 includes a storage section 81 which stores various types of information related to the coating processing. In addition, an input section 82 including a keyboard, a mouse, and the like for a user to perform an appropriate input operation, and a display section 83 including a liquid crystal display and the like for displaying appropriate information such as a setting screen of conditions related to coating processing and a state of the apparatus are connected to the control section 80.

Next, a flow of processing of coating the entire surface of the paper sheet 2 subjected to the printing processing by the electronic printer, with the UV varnish by the coating apparatus 1 of the first embodiment will be described.

The paper sheets 2 each having a surface subjected to printing processing by the electronic printer are stacked in advance on the stacking section 11 of the sheet feeding section 10 in a state where the printed surface (surface to be processed) faces upward.

When the user instructs the coating processing of the paper sheet 2 by a predetermined input operation through the input section 82, the control section 80 executes the coating processing of the paper sheet 2 as follows.

In the sheet feeding section 10, the paper sheets 2 stacked on the stacking section 11 are sent out to the toner aggregation section 20 one by one from the top. In the toner aggregation section 20, the printed layer of the paper sheet 2 is pressurized by being sandwiched between the upper roller 21 and the lower roller 22, and at the same time, the printed layer is heated by the halogen lamp 23 incorporated in the upper roller 21. The toner aggregation section 20 further heats and pressurizes the paper sheet 2 subjected to the printing processing by the electronic printer to aggregate the toner and fix the toner on the printing surface more reliably.

In the coating section 30, the UV varnish stored in the varnish reservoir 34 adheres to the entire peripheral surface of the upper roller 31. Subsequently, the UV varnish is removed from the peripheral surface of the upper roller 31 by the doctor blade 33, and only the UV varnish entering inside of the groove formed on the peripheral surface of the upper roller 31 remains. The upper roller 31 and the lower roller 32 sandwich the paper sheet 2 sent out from the sheet feeding section 10 and send out the paper sheet 2 forward. At this time, the upper roller 31 and the rigid roller portions located at both ends of the lower roller 32, which are made of a material having rigidity, contact each other without being deformed. On the other hand, the elastic roller portion is compressed and elastically deformed when contacting the upper roller 31. As a result, the paper sheet 2 is pressed against the upper roller 31, and the UV varnish flows out from the groove on the peripheral surface of the upper roller 31 and adheres to the upper surface of the paper sheet 2.

The paper sheet 2 sent out from the coating section 30 is then conveyed by the conveyance section 40 and enters the varnish curing section 50. In the varnish curing section 50, as described above, the paper sheet 2 is sandwiched and pressurized by the resin film pressing first upper roller 52 and the resin film pressing first lower roller 53, and at the same time, the paper sheet 2 is conveyed while being heated by the halogen lamp 57. As a result, similarly to the toner aggregation section 20, the toner layer aggregates and is more reliably fixed on the printing surface.

In addition, the resin film pressing first upper roller 52 and the resin film pressing first lower roller 53 press the resin film 58 supplied from the resin film supply roller 51 against the upper surface of the paper sheet 2, and airtightly attach the resin film 58 to the UV varnish-applied surface of the paper sheet 2. As a result, air (particularly oxygen) is removed from the UV varnish-applied surface, and the UV varnish applied to the applied surface is uniformly spread over the entire surface. Subsequently, the UV varnish is cured by being irradiated with ultraviolet light from the UV light source 56. Thereafter, the resin film 58 attached to the UV varnish-applied surface is collected by the resin film collection roller 55, and the UV varnish-coated paper sheet 2 is sent to the stacking section 60.

In an electronic printer, a reverse image formed on a surface of a drum with toner is transferred to a surface of a workpiece, and heat and pressure are applied to aggregate the toner and fix the toner on a printing surface to form a printed layer on the surface. As described above, the electronic printer also includes a mechanism that applies heat and pressure to fix the toner, but in some models, the degree of heating and pressurization may not be sufficient.

The present inventors prepared a test sheet by performing UV varnish coating processing on a paper sheet subjected to printing processing by various types of electronic printers sold by various companies, attached an adhesive tape to the surface of the test sheet, and then peeled off the adhesive tape, and found that the coated layer was peeled off together with the printed layer (toner layer) in the case of performing printing processing by some types of electronic printers.

In the coating apparatus 1 of the first embodiment, the printed layer of the paper sheet 2 is simultaneously heated and pressurized by the pressurizing roller pair including the upper roller 21 and the lower roller 22 of the toner aggregation section 20 to aggregate the toner and fix the toner on the printing surface more reliably. In addition, the printed layer of the paper sheet 2 is simultaneously heated and pressurized with intermediation of the resin film 58 by the pressurizing roller pair including the resin film pressing first upper roller 52 and the resin film pressing first lower roller 53 of the varnish curing section 50, and the toner is aggregated and more reliably fixed on the printing surface. As described above, by performing the processing of heating and pressurizing the printed layer of the paper sheet 2, it is possible to prevent the coated layer from peeling off after the coating processing is performed on the paper sheet 2 whose surface has been subjected to the printing processing by an electronic printer.

In electronic printers, polyester particles are often used as toner. Therefore, it is considered effective to heat and pressurize the printed layer of the paper sheet 2 under the condition of heating and pressurization such that the polyester particles are partially melted. Specifically, for example, the printed surface of the paper sheet 2 may be pressurized under a temperature condition of 80° C. or higher and lower than 150° C. When the present inventors used the same printed matter as the printed matter in which the coated layer and the toner layer were peeled off in the peeling test and performed the heating and pressurizing processing in the temperature range by the coating apparatus 1 of the first embodiment, only the adhesive tape could be peeled off without peeling the coated layer and the toner layer. That is, it was confirmed that the toner layer was sufficiently aggregated and fixed on the printing surface with sufficient strength. On the other hand, when the heating temperature was lowered to 60° C., the toner layer was not fixed with sufficient strength and peeled off together with the coated layer. In addition, when the heating temperature exceeds 150° C., there is a possibility that the toner is dissolved and becomes liquid to be separated from the workpiece. Of course, the heating and pressurization conditions are merely examples, and the heating and pressurization conditions (temperature and pressure) may be appropriately determined in consideration of the state of the printed layer (toner fixed state) and the like based on the result of performing the peeling test on the paper sheet 2 to be subjected to the coating processing or a test sheet created using an electronic printer of the same model as the printer used to create the paper sheet to be subjected to the coating processing. Note that, it is a matter of course that the upper roller 21 and the resin film pressing first upper roller 52 are made of a material having sufficient heat resistance at a temperature heated by the heat sources of the halogen lamps 23 and 57 incorporated in the upper roller 21 and the resin film pressing first upper roller 52, respectively.

The upper roller 21 of the toner aggregation section 20 is in direct contact with the printed surface of the paper sheet 2 to pressurize the printed layer. If a rubber roller having a large friction coefficient (for example, a friction coefficient of 2.3 or more in Patent Literature 2) as used in a general conveyance mechanism which conveys a sheet is used, toner may adhere to the surface of the roller. Therefore, it is preferable that the surface of the upper roller 21 located on the side in contact with the printed surface is made of a material having a small friction coefficient. In the first embodiment, as the upper roller 21 of the toner aggregation section 20, a roller obtained by winding a fluororesin tube 212 having a small friction coefficient of 0.1 around the surface of the roller 211 made of rubber is used, so that the adhesiveness and wettability of the surface are lowered to prevent the toner from being transferred from the printed layer. In the first embodiment, the friction coefficient is used as an index for lowering the adhesiveness and the wettability of the surface of the upper roller 21. However, the surface of the upper roller 21 may be made of a material selected based on an index other than the friction coefficient as long as the physical quantity reflects the characteristics of low adhesiveness and low wettability. In addition, since the surface of the other roller (lower roller 22) constituting the pressurizing roller pair is made of rubber having sufficient elasticity, the entire surface of the paper sheet 2 can be uniformly pressurized when the paper sheet 2 is sandwiched.

Next, the coating apparatus 100 of the second embodiment will be described. In the following description, components common to those of the coating apparatus 1 of the first embodiment are denoted by the same reference numerals, and description thereof is omitted as appropriate.

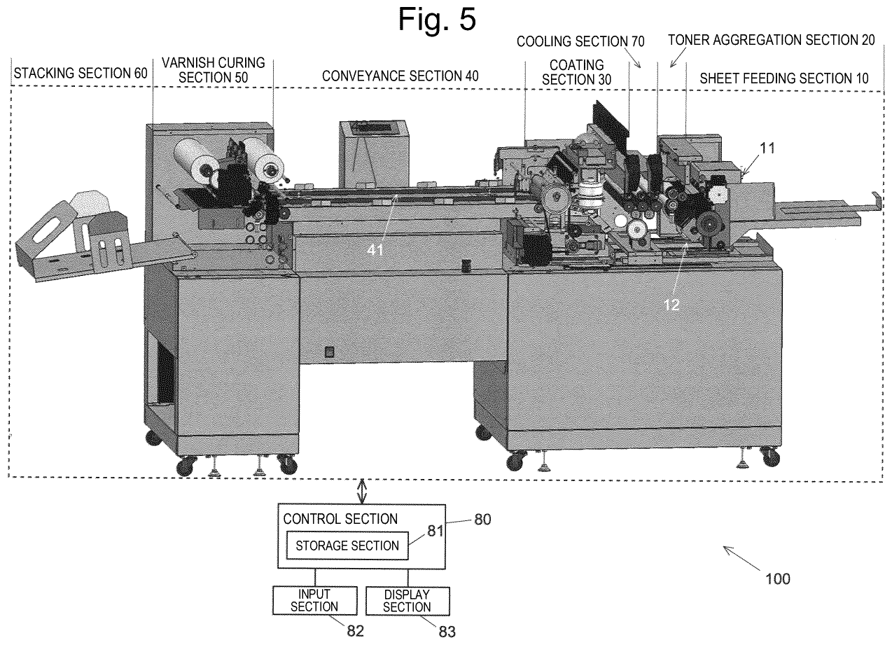

FIG. 5 is an overall perspective view of the coating apparatus 100 according to the second embodiment. Similarly to FIG. 1, in order to illustrate the internal structure, the upper surface and the side surface on the front side of the external casing and a part of the components inside the apparatus are not illustrated. The coating apparatus 100 includes a workpiece cooling section 70 in addition to the sheet feeding section 10, the toner aggregation section 20, the coating section 30, the conveyance section 40, the varnish curing section 50, and the stacking section 60, which are components similar to those of the first embodiment. The workpiece cooling section 70 is disposed between the toner aggregation section 20 and the coating section 30.

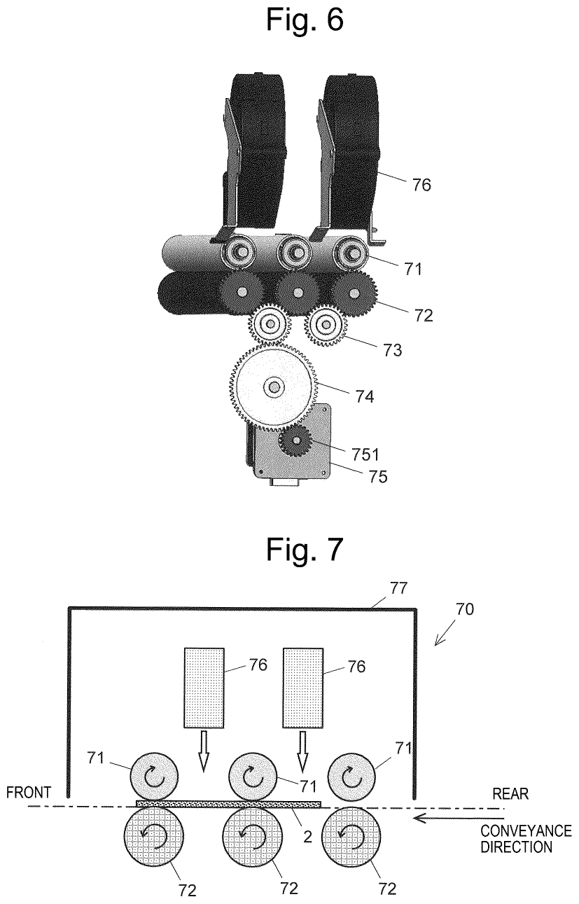

The workpiece cooling section 70 is an apparatus that cools the printed surface heated in the toner aggregation section 20. FIG. 6 is an enlarged view of characteristic components in the workpiece cooling section 70, and FIG. 7 illustrates a section in the vicinity of the conveyance path of the paper sheet 2.

The workpiece cooling section 70 includes three upper rollers 71 provided on the upper side of the conveyance path of the paper sheet 2 and three lower rollers 72 provided on the lower side of the conveyance path at positions facing the upper rollers 71. A roller pair including the upper roller 71 and the lower roller 72 corresponds to a cooling roller pair in the present invention. As the upper rollers 71, it is preferable to use rollers in which at least a surface in contact with the printed surface is made of a material having high thermal conductivity. Generally, metal has high thermal conductivity, and thus, for example, rollers made of metal at least on the surfaces is suitably used for the upper rollers 71. The upper rollers 71 in the second embodiment are aluminum pipe rollers. Aluminum is particularly suitable for the upper rollers 71 because it has a high thermal conductivity and is relatively inexpensive. Since the paper sheet 2 generally has a heat insulating property, even if the surfaces of the lower rollers 72 are made of a material having a high thermal conductivity, the effect of cooling the printed surface is small. Therefore, in the present embodiment, rubber rollers are used as the lower rollers 72. As a matter of course, the lower rollers 72 may have a high heat release effect similarly to the upper rollers 71.

Gears are formed at one end of each of the three lower rollers 72 (on the front side of the drawing sheet in FIG. 6), and first gears 73 having a flat plate shape are each disposed so as to mesh with the gears of the two lower rollers 72 located adjacently. In addition, a second gear 74 is disposed so as to mesh with the first gear 73 and a gear 751 of a motor 75. Therefore, when the motor 75 is operated, the lower rollers 72 are rotated via the second gear 74 and the first gears 73, and the upper rollers 71 are rotated following the rotation of the lower rollers 72 in a state where the paper sheet is sandwiched.

Blower fans 76 which blow air downward are disposed at positions (two positions) between two adjacent upper rollers above the upper rollers 71. Although not illustrated in FIG. 6, in the workpiece cooling section 70, a ventilation guide 77 having openings on both sides in a horizontal direction orthogonal to the conveyance direction of the paper sheet is disposed so as to cover the above-described components. Here, the blower fans 76 which blow air are used, but a gas other than air may be blown.

Also in the coating apparatus 100 of the second embodiment, similarly to the coating apparatus 1 of the first embodiment, in the toner aggregation section 20, the paper sheet 2 is sandwiched between the upper roller 21 and the lower roller 22 to pressurize the printed surface, and at the same time, the printed layer is heated by the halogen lamp 23 incorporated in the upper roller 21. The toner aggregation section 20 heats and pressurizes the paper sheet 2 subjected to the printing processing by the electronic printer to aggregate the toner and fix the toner to the printing surface more reliably.

In the coating apparatus 100 of the second embodiment, the paper sheet 2 heated in the toner aggregation section 20 is conveyed by three pairs of upper rollers 71 and lower rollers 72. At this time, since at least the surfaces of the upper rollers 71 are made of a material (aluminum or the like) having a high thermal conductivity, when the printed surface of the paper sheet 2 and the upper rollers 71 contact each other, heat is transferred from the paper sheet 2 to the upper rollers 71, and the printed surface is cooled. In addition, the printed surface is also cooled by blowing air from the blower fans 76 to the paper sheet 2. Furthermore, air is also blown from the blower fans 76 to the upper rollers 71, and the upper rollers 71 which have absorbed heat from the paper sheet 2 are also cooled. In addition, by providing the ventilation guide 77 whose both surfaces in the horizontal direction orthogonal to the conveyance direction of the paper sheet are opened, the flow of the air blown from the blower fans 76 is regulated.

As described above, in the coating apparatus 1 of the first embodiment, the printed layer of the paper sheet 2 is simultaneously heated and pressurized by the pressurizing roller pair including the upper roller 21 and the lower roller 22 of the toner aggregation section 20 to aggregate the toner and fix the toner on the printing surface more reliably, so that the coated layer can be prevented from peeling off after the coating processing is performed on the paper sheet 2. On the other hand, in the coating apparatus 1 according to the first embodiment, fine streaks (ridges) may be generated on the UV-coated paper sheet due to various factors such as the characteristics of the paper sheet 2 (the thickness of the workpiece, etc.), the viscosity and surface tension of the varnish, the conveyance speed of the paper sheet 2, and the like.

The inventors of the present invention adjusted various parameters in the coating apparatus 1 according to the first embodiment and performed coating processing on the paper sheet to find a cause of generation of ridges on the paper sheet subjected to coating processing. Then, for example, in a case where only pressurization is performed in the toner aggregation section 20 and the paper sheet 2 is not heated but coating processing is performed, it has been found that ridges are not generated. In addition, it has been found that the number and size of generated ridges decrease when the heating temperature of the paper sheet 2 in the toner aggregation section 20 is lowered. From such results, the inventors of the present invention have found that the fact that the paper sheet 2 heated in the toner aggregation section 20 enters the coating section 30 while being at a high temperature, and the UV varnish is applied to the paper sheet 2 at a high temperature is a main cause of generation of ridges on the UV-coated paper sheet.

The coating apparatus 100 of the second embodiment is an improvement of the coating apparatus 1 of the first embodiment based on the above findings. In the coating apparatus 100 of the second embodiment, as described above, the printed surface of the paper sheet 2 heated in the toner aggregation section 20 is cooled by being brought into contact with the upper rollers 71 in the workpiece cooling section 70, and is also cooled by blowing air from the blower fan 76. When the present inventors performed the coating processing using the coating apparatus 100 of the second embodiment on the paper sheet 2 on which the ridges were generated by the coating processing using the coating apparatus 1 of the first embodiment, it was confirmed that the ridges are not generated on the paper sheet 2 after the coating processing. From the test conducted by the present inventors, it has been found that, although depending on the configuration of the paper sheet 2 and the printed layer, in many cases, when the workpiece cooling section 70 cools the temperature of the printed surface of the paper sheet 2 to, for example, about 60 to 70° C. and supplies the paper sheet 2 to the coating section 30, no ridge is generated on the paper sheet 2.

The coating apparatus 1 of the above embodiment and the coating apparatus 100 of the second embodiment are examples, and can be appropriately changed in accordance with the gist of the present invention. In the above embodiments, the case where the coating processing is performed on the paper sheet 2 has been described. However, the coating processing can be performed not only on the paper sheet but also on a surface of a sheet of paper or a sheet other than paper. In addition, the coating processing can be performed not only on a sheet but also on a surface of a plate. In addition, coating processing using a liquid coating agent other than the UV varnish can also be performed.

In the above embodiments, the case where the coating processing is performed on the paper sheet 2 printed on one side has been described, but the present invention can also be used in a case where the coating processing is performed on the paper sheet 2 printed on both sides (that is, both the front and back surfaces of the paper sheet 2 are subjected to the coating processing). In this case, for the surface of the lower roller 22, in addition to the upper roller 21, it is preferable to use a material (for example, fluororesin) having a small friction coefficient (for example, 0.1 or less). In addition, in a case where the coating processing is performed on both surfaces, a mechanism may be provided in which the varnish curing section 50 is provided above and below the conveyance path to coat both surfaces at the same time, or a mechanism may be provided in which the varnish curing sections 50 are provided at two places and the upper and lower surfaces of the paper sheet 2 are reversed in the conveyance path between the varnish curing sections 50. Furthermore, in the second embodiment, in addition to the upper rollers 71 of the workpiece cooling section 70, also for the lower rollers 72, it is preferable to use a material having at least high thermal conductivity.

In addition, in the above embodiments, a material having a small friction coefficient is used for the surfaces of the upper roller 21 and the resin film pressing first upper roller 52, but this is intended to suppress transfer of toner from the printing surface, and other configurations can be adopted as long as this object can be achieved. For example, an upper roller and a lower roller which are rubber rollers may be used, and an insertion member in which a surface on a side in contact with the printed surface is made of a material having a small friction coefficient (for example, 0.1 or less) may be disposed between the upper roller and the printed surface of a workpiece such as the paper sheet 2.

In the above embodiments, the pressurizing roller pair for heating and pressurizing the printed layer of the paper sheet 2 is disposed at two positions of the toner aggregation section 20 and the varnish curing section 50, but may be disposed at only one of the positions. In the case of disposing the pressurizing roller pair on only one side, it is preferable to dispose the pressurizing roller pair at a position where the printed layer can be directly pressurized, that is, on the upstream side of the section where coating processing is performed (coating section 30). In addition, in the above embodiments, the resin film pressing first upper roller 52 used in the varnish curing section 50 has the same configuration as the upper roller 21 of the toner aggregation section 20, but since the resin film pressing first upper roller 52 pressurizes the printed layer of the paper sheet 2 with intermediation of the resin film 58, there is no concern that the toner adheres, and the surface may not necessarily be formed of a material having a small friction coefficient.

In the above embodiments, the printed surface of the paper sheet 2 is pressurized and simultaneously heated using the halogen lamp 23 incorporated in the upper roller 21 of the toner aggregation section 20 and the halogen lamp 57 incorporated in the resin film pressing first upper roller 52 of the varnish curing section 50. However, the printed surface may not necessarily be pressurized and heated simultaneously. Specifically, for example, a heating section may be separately provided on the upstream side of the pressurizing roller pair not incorporating the heating section, and the printed surface may be pressurized after the printed surface is heated by the heating section. In addition, as the heat source, a heat source other than the halogen lamp can also be used. However, as in the above embodiments, by incorporating the heating section in the roller and simultaneously performing the pressurization and heating of the printed surface, the apparatus can be downsized, and the toner can be effectively aggregated and fixed to the printing surface.

In the above embodiments, the apparatus for coating, with the UV varnish, the printed surface of the paper sheet 2 subjected to the printing processing by the electronic printer has been described, but the same configuration as described above can also be adopted for an apparatus performing other types of coating. For example, also in an apparatus that performs aqueous coating processing to a printed surface of a workpiece, by adopting a configuration in which the printed surface is pressurized and heated in the same manner as described above, it is possible to suppress peeling of the coated layer and the printed layer by aggregating the toner and fixing the toner on the printing surface.

In the above embodiments, the integrated coating apparatus 1 includes the toner aggregation section 20 and both the coating section 30 and the varnish curing section 50, but may include the toner aggregation section 20, the coating section 30, and the varnish curing section 50 individually. For example, when an existing coating apparatus is present, a toner aggregation apparatus having the toner aggregation section 20 may be prepared separately from the existing coating apparatus, and the coating processing may be performed by the coating apparatus after the toner is aggregated and fixed on the printing surface by the toner aggregation apparatus. Alternatively, after the coating processing is performed by the coating apparatus, the toner may be aggregated by the toner aggregation apparatus and fixed on the printing surface. In addition, a coating system may be employed in which a toner aggregation apparatus having the toner aggregation section 20 and a coating apparatus are individually provided, and the printed surface of the workpiece before being subjected to the coating processing by the coating apparatus and/or the printed surface of the workpiece after being subjected to the coating processing by the coating apparatus are heated and pressurized to aggregate and fix the toner on the printing surface.

In the workpiece cooling section 70 according to the second embodiment, the paper sheet 2 is cooled using the upper rollers 71 whose surfaces are made of a material having a high thermal conductivity and the blower fans 76. However, the workpiece cooling section 70 may have any configuration capable of cooling the paper sheet 2 (such as a configuration in which cooling water is supplied into a metal roller having a high thermal conductivity such as aluminum).

### [Modes]

It is obvious for those skilled in the art that the exemplary embodiments described above are specific examples of the following modes.

### (Clause 1)

A coating apparatus according to one mode of the present invention includes:
a coating processing section configured to perform predetermined coating processing on a printed surface of a workpiece that is a sheet-shaped object or a plate-shaped object having a surface subjected to electronic printing processing;
a pressurizing roller pair disposed on an upstream side or a downstream side of the coating processing section and configured to sandwich, pressurize and convey the workpiece; and
a heating section disposed at the same position as or on an upstream side of the pressurizing roller pair with respect to a conveyance direction of the workpiece and configured to heat the printed surface of the workpiece.

### (Clause 2)

A coating apparatus according to Clause 2 is the coating apparatus according to Clause 1, in which
the heating section is configured to heat the printed surface of the workpiece simultaneously with pressurization by the pressurizing roller pair.

### (Clause 3)

A coating apparatus according to Clause 3 is the coating apparatus according to Clause 1 or Clause 2, in which
the heating section is incorporated in one roller of the pressurizing roller pair, the one roller being disposed on a side of the printed surface.

### (Clause 4)

A coating apparatus according to Clause 4 is the coating apparatus according to any one of Clause 1 to Clause 3, in which
the pressurizing roller pair is disposed on the upstream side of the coating processing section, and
a surface of one roller of the pressurizing roller pair, the one roller being located on a side in contact with the printed surface, is made of a material having a friction coefficient of 0.1 or less.

### (Clause 5)

A coating apparatus according to Clause 5 is the coating apparatus according to any one of Clause 1 to Clause 4, further including
a workpiece cooling section provided between the pressurizing roller pair and the coating processing section and configured to cool the printed surface heated by the heating section.

### (Clause 6)

A coating apparatus according to Clause 6 is the coating apparatus according to Clause 5, in which
the workpiece cooling section includes a cooling roller pair configured to sandwich and convey the workpiece, and at least a surface of a roller in contact with the printed surface of the workpiece is made of metal.

### (Clause 7)

A coating apparatus according to Clause 7 is the coating apparatus according to Clause 5 or Clause 6, in which
the workpiece cooling section includes a blowing section configured to blow gas to the printed surface of the workpiece.

### (Clause 8)

A coating apparatus according to Clause 8 is the coating apparatus of Clause 7, in which
the workpiece cooling section further includes a flow regulating section provided to surround the blowing section and configured to regulate a flow of gas blown to the workpiece from the blowing section.

### (Clause 9)

A coating apparatus according to Clause 9 is the coating apparatus according to any one of Clause 1 to Clause 8, in which
a surface of one roller of the pressurizing roller pair, the one roller being disposed on a side of the printed surface, is made of fluororesin. Note that the coating apparatus according to Clause 5 includes a coating apparatus in which surfaces of both rollers of the pressurizing roller pair are made of fluororesin.

### (Clause 10)

A coating apparatus according to Clause 10 is the coating apparatus according to any one of Clause 1 to Clause 9, further including
an insertion member inserted between one roller of the pressurizing roller pair, the one roller being disposed on a side of the printed surface, and the printed surface, and has a surface on a side in contact with the printed surface, the surface being made of a material having a friction coefficient of 0.1 or less.

### (Clause 11)

A coating system according to one mode of the present invention includes:
a coating apparatus including a coating processing section configured to perform predetermined coating processing on a printed surface of a workpiece that is a sheet-shaped object or a plate-shaped object having a surface subjected to electronic printing processing; and
a toner aggregation apparatus including a pressurizing roller pair and a heating section, the pressurizing roller pair being configured to sandwich, pressurize and convey the workpiece before being subjected to the coating processing by the coating apparatus and/or the workpiece after being subjected to the coating processing by the coating apparatus, the heating section being disposed at the same position as or on an upstream side of the pressurizing roller pair with respect to a conveyance direction of the workpiece and configured to heat the printed surface of the workpiece.

### REFERENCE SIGNS LIST

1 . . . Coating Apparatus
2 . . . Paper Sheet
10 . . . Sheet Feeding Section
11 . . . Stacking Section
12 . . . Conveyance Mechanism
20 . . . Toner Aggregation Section
21 . . . Upper Roller
211 . . . Rubber Roller
212 . . . Fluororesin Tube
22 . . . Lower Roller
23 . . . Halogen Lamp
30 . . . Coating Section
31 . . . Upper Roller
32 . . . Lower Roller
33 . . . Doctor Blade
34 . . . Varnish Reservoir
35 . . . Varnish Supply Section
40 . . . Conveyance Section
41 . . . Conveyance Table
42 . . . Belt
50 . . . Varnish Curing Section
51 . . . Resin Film Supply Roller
52 . . . Resin Film Pressing First Upper Roller
521 . . . Rubber Roller
522 . . . Fluororesin Tube
53 . . . Resin Film Pressing First Lower Roller
54 . . . Resin Film Pressing Second Roller
55 . . . Resin Film Collection Roller
56 . . . UV Light Source
57 . . . Halogen Lamp
58 . . . Resin Film
60 . . . Stacking Section
70 . . . Workpiece Cooling Section
71 . . . Upper Roller
72 . . . Lower Roller
73 . . . First Gear
74 . . . Second Gear
75 . . . Motor
751 . . . Gear
76 . . . Blower Fan
77 . . . Ventilation Guide
80 . . . Control Section
81 . . . Storage Section
82 . . . Input Section
83 . . . Display Section

1. A coating apparatus comprising:
a coating processing section configured to perform coating processing using a liquid coating agent on a printed surface of a workpiece that is a sheet-shaped object or a plate-shaped object having a surface subjected to electronic printing processing;
a pressurizing roller pair disposed on an upstream side or a downstream side of the coating processing section and configured to sandwich, pressurize and convey the workpiece; and
a heating section disposed at a same position as or on an upstream side of the pressurizing roller pair with respect to a conveyance direction of the workpiece and configured to heat the printed surface of the workpiece.

2. The coating apparatus according to claim 1, wherein
the heating section is configured to heat the printed surface of the workpiece simultaneously with pressurization by the pressurizing roller pair.

3. The coating apparatus according to claim 1, wherein
the heating section is incorporated in one roller of the pressurizing roller pair, the one roller being disposed on a side of the printed surface.

4. The coating apparatus according to claim 1, wherein
the pressurizing roller pair is disposed on the upstream side of the coating processing section, and
a surface of one roller of the pressurizing roller pair, the one roller being located on a side in contact with the printed surface, is made of a material having a friction coefficient of 0.1 or less.

5. The coating apparatus according to claim 4, further comprising
a workpiece cooling section provided between the pressurizing roller pair and the coating processing section and configured to cool the printed surface heated by the heating section.

6. The coating apparatus according to claim 5, wherein
the workpiece cooling section includes a cooling roller pair configured to sandwich and convey the workpiece, and at least a surface of a roller in contact with the printed surface of the workpiece is made of metal.

7. The coating apparatus according to claim 5, wherein the workpiece cooling section includes a blowing section configured to blow gas to the printed surface of the workpiece.

8. The coating apparatus according to claim 7, wherein the workpiece cooling section further includes a flow regulating section provided to surround the blowing section and configured to regulate a flow of gas blown to the workpiece from the blowing section.

9. The coating apparatus according to claim 1, wherein
a surface of one roller of the pressurizing roller pair, the one roller being disposed on a side of the printed surface, is made of fluororesin.

10. The coating apparatus according to claim 1, further comprising
an insertion member inserted between one roller of the pressurizing roller pair, the one roller being disposed on a side of the printed surface, and the printed surface, and has a surface on a side in contact with the printed surface, the surface being made of a material having a friction coefficient of 0.1 or less.

11. A coating system comprising:
a coating apparatus including a coating processing section configured to perform coating processing using a liquid coating agent on a printed surface of a workpiece that is a sheet-shaped object or a plate-shaped object having a surface subjected to electronic printing processing; and
a toner aggregation apparatus including a pressurizing roller pair and a heating section, the pressurizing roller pair being configured to sandwich, pressurize and convey the workpiece before being subjected to the coating processing by the coating apparatus and/or the workpiece after being subjected to the coating processing by the coating apparatus, the heating section being disposed at a same position as or on an upstream side of the pressurizing roller pair with respect to a conveyance direction of the workpiece and configured to heat the printed surface of the workpiece.
